(19) United States
(12) Patent Application Publication
(10) Pub. No.: US 2009/0196972 A1
(43) Pub. Date: Aug. 6, 2009

(54) Natural Flavor Enhancement Compositions for Food Emulsions

(76) Inventors: Adelmo Monsalve-Gonzalez, Lakeville, MN (US); Maria Ochomogo, Danville, CA (US)

Correspondence Address: THE CLOROX COMPANY, P.O. BOX 24305, OAKLAND, CA, 94623-1305, US

(21) Appl. No.: 12/025,467

(22) Filed: Feb. 4, 2008

(51) Int. Cl. A23L 1/226; A23L 1/221

(52) U.S. Cl. 426/534; 426/651

(57) ABSTRACT

The present invention is directed to a food emulsion composition, in the form of a nanoemulsion, comprising a food safe nonionic surfactant, alcohol co-solvent and an essential oil. The food emulsion composition can be used for a wide variety of food and beverage compositions, including but not limited to, dressings, marinades, sauces, condiments, beverages and the like. The encapsulated nanoemulsion flavorant compositions are beneficial because they make flavorants appear comparable with other compositions with twice the amount of flavorants which are non-encapsulated in an nanoemulsion. In addition, the nanoemulsion compositions better stability and show less signs of oxidation over time at room temperature than non-encapsulated formulations. Less oxidation and better stability results in lesser appearance of rancid aromas and bitter flavors.

### BACKGROUND OF THE INVENTION

1. Field of the Invention

The present invention relates to a food emulsion composition with natural flavorants. Standard emulsions which have been widely used in food and beverage technology, cosmetics, or pharmaceutical formulations for many years, often appear opaque or cloudy and unstable. In contrast, microemulsions and nanoemulsions emulsions, including the micellar solutions, are usually transparent dispersions that form spontaneously without the need of energy input, when the compounds thereof are properly mixed with each other. Due to the very small size of dispersed oil-droplets, in fact in most cases the dispersed oil-droplets are less than 140 nm in diameter, the visible light cannot be scattered and therefore microemulsions appear as clear or translucent isopropic solutions.

A classical oil-in-water microemulsion or nanoemulsion consists of water, a co-solvent such as alcohol, oil and one or more surfactants and co-surfactants. Although microemulsions and nanoemulsions form spontaneously, when they form, the selection of the components thereof and their relative amounts are very critical for their formation, their final characteristics such as optical appearance, and their organoleptic and thermodynamic time-stability. In addition, when such microemulsions or nanoemulsions are used as flavor delivery systems in food products, for example in beverages, they must fulfill all the requirements of these products, namely an excellent shelf-life stability over a large temperature range, for a series of months without deteriorating and causing rancid aromas and bitter flavors.

2. Description of Related Art

Emulsions have been widely used in food and beverage technology, cosmetics, or pharmaceutical formulations for many years. Nevertheless, their limited thermodynamic stability, which means that they separate into their two original liquid phases on standing, represents the biggest drawback in application. Due to their time limited thermodynamic stability, all the emulsion based products will undergo oil-ringing formation, and finally phase separation.

Unlike emulsions, the microemulsions, including the micellar solutions, are usually transparent dispersions that form spontaneously without the need of energy input, when the compounds thereof are properly mixed with each other. Due to the very small size of dispersed oil-droplets, in fact in most cases the dispersed oil-droplets are less than 140 nm in diameter, the visible light cannot be scattered and therefore microemulsions appear as clear or translucent isopropic solutions.

A classical oil-in-water microemulsion consists of water, a co-solvent, oil and one or more surfactants and co-surfactants. Although microemulsions form spontaneously, when they form, the selection of the components thereof and their relative amounts are very critical for their formation, their final characteristics such as optical appearance, and their organoleptic and thermodynamic time-stability. In addition, when such microemulsions are used as flavor delivery systems in food products, for example in beverages, they must fulfill all the requirements of these products, namely an excellent shelf-life stability over a large temperature range, at least a few months, and no formation of off-notes.

In the field of beverage flavoring, the use of microemulsions has been described in particular by Wolf et al. in U.S. Pat. No. 4,835,002. The latter document discloses microemulsions of edible oils in a matrix of water and certain alcohols, together with food-grade surfactants. More particularly, this document describes compositions comprising from 0.01 to 45% by weight, and preferably from 1 to 25% by weight, of oil, from about 0.1 to 60%, and preferably from 1 to 30% by weight, of surfactant and from 20 to 95%, and preferably 25 to 80% by weight, of a polyol including ethanol, propylene glycol, sugars such as dextrose, sucrose, fructose and other. The proportion of alcohol needed in said microemulsion compositions is of at least 20% by weight in order to obtain a clear system. Propylene glycol is selected as preferred alcohol. Unlike the present invention, which does not require a high level of a polyol for formation of the nanoemulsion and even when an alcohol co-solvent is added to the emulsion it is at a level of less than 20%.

U.S. Pat. No. 5,283,056 to Chung et al., describes compositions of transparent oil-in-water microemulsion concentrates, consisting essentially of water, one or more hydrophobic flavor or fragrance oils and one or more surfactants. Said microemulsions are especially intended for the preparation of mouthwash solutions and are essentially free of lower alkanols. Nevertheless, these compositions comprise large amounts of surfactant, particularly when high oil content is required. Moreover, the claimed microemulsions show poor shelf-life stability even at room temperature, which would not be convenient for food emulsion applications such as dressings, sauces and the like.

In the prior art there are other formulations of microemulsions and nanoemulsions which contain an essential oils, alcohols and a surfactants, they do not contain these component in the same amounts as the present invention and they do not combine them into food emulsions in a way to enhance the taste and flavor of the flavorants in the composition. In addition, formulating aqueous food emulsions with oil based flavorants can be challenging because they are not readily miscible in water. As a result, essential oils and other oil based flavorants are often difficult to prepare in a form that will allow them to be readily incorporated into an aqueous solution. There is a need for a food emulsion composition that is stable and resists oxidation for longer periods of time than traditional emulsions and enhances the perception of flavorants in a food emulsion.

There exists an unmet need to establish a novel and advantageous formulation of edible, perfectly clear, micro and nano emulsions that are entirely composed of food grade quality components, which comprise a very low levels of surfactant/co-surfactant, and which prove excellent organoleptically and from the point of view of the thermodynamic stability, both as emulsions end and in end-products where they may be employed as flavor carriers.

### SUMMARY OF THE INVENTION

The present invention relates to a natural flavor enhancement food emulsion composition comprising: a food safe non-ionic surfactant, a hydrophobic food flavorant, an alcohol co-solvent and water. The food emulsion is in the form of a microemulsion or a nanoemulsion which is clear and thermodynamically stable. The encapsulation of the flavorant in the micro or nano emulsion structure protects the flavorant from oxidation which means that the food emulsion does not deteriorate as rapidly at room temperature as non-encapsulated flavorants. In addition, the natural flavorant food emulsion exhibits superior flavor and aroma intensity to comparable undiluted, non-encapsulated essential oil formulations.

Essential oils, oleoresins and oil based natural flavors are commonly used as flavoring substances in food type emulsions. These flavor substances are readily miscible in the oil (hydrophobic) phase and, depending on the partition coefficient, negligible amounts of the flavor substances are dissolved in the aqueous (hydrophilic) phase of the food emulsion. As a result, essential oils and hydrophobic flavors find limited use in flavoring oil in water emulsion or need to be incorporated with the oil phase to be readily miscible into the hydrophobic phase of the food emulsion. In addition, essential oils and hydrophobic flavors are prone to deterioration via oxidation.

The use of self assembled microemulsion, or nanoemulsion, to encapsulate hydrophobic flavors, such as essential oils, permits the dispersion of the hydrophobic flavoring substances into the aqueous phase of the food emulsion. Surprisingly, the encapsulation and dispersion of the flavors into the aqueous phase of the food type emulsions augment or enhance up to three fold their flavoring intensities when compared to the non-encapsulated flavor counterparts. The micro or nano encapsulation also protects the flavoring substances against oxidation by creating a physical barrier that impedes or minimize their interaction with the oxygen in the emulsion.

The food emulsion composition comprises: a flavorant, a food safe nonionic surfactant and water. The flavorant component of the present invention is present at levels from about 3% to about 15%, by weight of the nanoemulsion composition, preferably from about 5% to 13%, and most preferably from about 5% to about 10%. The levels of alcohol co-solvent useful in the present invention are about 8% to about 25%, by weight of the nanoemulsion composition, preferably from about 10% to 20%, and most preferably from about 10% to about 15%. The level food safe surfactants of the present invention are present at levels of from at least 20%, by weight of the composition, preferably from about 25% to about 63%, and more preferably from about 25% to about 50%. The nonionic surfactants selected preferably have a hydrophilic-lipophilic balance (HLB) greater than about 10, more preferably a HLB of about 13 or greater. The remainder of the nanoemulsion composition includes water. The amount of water in the nanoemulsion may be greater than 40% by weight, more preferably 50% by weight and most preferably 55% by weight.

In one embodiment of the invention, the nanoemulsion is created so that there is about 5-12.5% by weight of flavorant, there is at least two times as much alcohol co-solvent as the flavorant, and there is at least five times as much food safe nonionic surfactant as the flavorant and the remainder is water. In this embodiment the ratio of flavorant to alcohol co-solvent is about 1:2 to about 1:5 and the ratio of flavorant to food safe nonionic surfactant is about 1:5 to 1:12. As described, the food emulsion provides for a novel and completely natural food emulsion composition, which exhibits excellent taste and stability properties.

The food emulsion composition is in the form of a stable and clear micro or nanoemulsion. The present invention provides microemulsions formed by mixing of an oil phase (flavorant), an aqueous phase (water) and a food safe nonionic surfactant. The microemulsions of the present invention form spontaneously and create a nano self-structured liquid (NSSL). The NSSL is thermodynamically stable over a wide range of temperatures and has droplets in the size range of 10 to 200 nm, preferably from about 10 to 100 nm and more preferably 10 to about 50 nm. The NSSL is also aesthetically clear and stable upon dilution and forms droplets in the range of about 10 to 100 nm.

The features and advantages of composition of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### DETAILED DESCRIPTION OF THE PREFERRED EMBODIMENTS

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

References herein to “one embodiment”, “one aspect” or “one version” of the invention include one or more such embodiment, aspect or version, unless the context clearly dictates otherwise.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (“%'s”) are in weight percent (based on 100% active) of the active composition alone, not accounting for the substrate weight. Each of the noted food emulsion composition components is discussed in detail below.

The precise definition of a “flavorant” is difficult since its literal definition includes anything that contributes flavor to food. A legal definition by the U.S. Code of Federal Regulations, a natural flavorant is: “the essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or any other edible portions of a plant, meat, seafood, poultry, eggs, dairy products, or fermentation products thereof, whose primary function in food is flavoring rather than nutritional.”

The term flavorant includes, but is not limited to, essential oils, oleoresins, oil-based natural flavors and mixtures and combinations thereof. An “essential oil” is any concentrated, hydrophobic liquid containing volatile aroma compounds from plants. Essential oils are natural products commonly used in foods and beverages for their fragrance and taste properties. “Oleoresins” which are a naturally occurring mixture of an oil and a resin extracted from various plants. Any other suitable oil-based natural flavors should also be included in the term flavorants.

The term “food safe” refers to compositions, which are comprised entirely of materials that are considered food grade, and/or Generally Recognized As Safe (GRAS) and/or Everything Added to Food in the U.S. (EAFUS). In the United States, ingredients pre-approved for food use are listed in the United States Code of Federal Regulations (“C.F.R.”), Title 21. The term “food safe” includes compositions are both safe and suitable for direct application to food work surfaces, including but not limited to, cutting boards, sinks, and kitchen counter tops, as well as direct food contact surfaces, including but not limited to, plates, platters and silverware. Food safe materials may also include ingredients that are well established as safe, or have adequate toxicological and safety pedigree, can be added to existing lists or approved via a self-affirmation process.

### Flavorant

The flavorant component of the present invention is present at levels from about 3% to about 15%, by weight of the food emulsion composition, preferably from about 5% to 12%, and most preferably from about 5% to about 10%. The food emulsion composition of the present invention may be formulated as either a concentrated nanoemulsion composition which can be added to a wide variety of food emulsions or a portion of a more dilute food emulsion that is ready to use. The ratio of the flavorant to the nonionic food safe surfactant should be at least a 1:2 ratio. The ratio of flavorant to nonionic food safe surfactant is preferably from about 1:2 to about 1:5, preferably from 1:2 to about 1:4 and most preferably from 1:2 to about 1:3.

The essential oils preferred for use in the aqueous compositions of this invention are those essential oils, which can form a microemulsion when combined with a water carrier and a nonionic surfactant. Suitable essential oils include, but are not limited to, those obtained from mint, tea tree, parsley, thyme, lemongrass, lemons, limes, grapefruit, oranges, anise, clove, roses, lavender, citronella, eucalyptus, peppermint, camphor, sandalwood, cedar and pine. Preferred essential oils include mint oil, tea tree oil, lavender oil, pine oil, lemongrass oil, lemon oil, parsley oil, orange oil and clove oil. The most preferred essential oils are mint oil, tea tree oil, lemon oil, orange oil, lime oil, grapefruit oil, mint oil, parsley oil, lemongrass oil and combinations thereof.

Other suitable essential oils include, but are not limited to: Anethole 20/21 natural, Aniseed oil china star, Aniseed oil globe brand, Balsam (Peru), Basil oil (India), Black pepper oil, Black pepper oleoresin 40/20, Bois de Rose (Brazil) FOB, Borneol Flakes (China), Camphor oil, White, Camphor powder synthetic technical, Cananga oil (Java), Cardamom oil, Cassia oil (China), Cedarwood oil (China) BP, Cinnamon bark oil, Cinnamon leaf oil, Citronella oil, Clove bud oil, Clove leaf, Coriander (Russia), Coumarin 69° C. (China), Cyclamen Aldehyde, Diphenyl oxide, Ethyl vanilin, Eucalyptol, Eucalyptus oil, Eucalyptus citriodora, Fennel oil, Geranium oil, Ginger oil, Ginger oleoresin (India), White grapefruit oil, Guaiacwood oil, Gurjun balsam, Heliotropin, Isobornyl acetate, Isolongifolene, Juniper berry oil, L-methyl acetate, Lavender oil, Lemon oil, Lemongrass oil, Lime oil distilled, Litsea Cubeba oil, Longifolene, Menthol crystals, Methyl cedryl ketone, Methyl chavicol, Methyl salicylate, Musk ambrette, Musk ketone, Musk xylol, Nutmeg oil, Orange oil, Patchouli oil, Peppermint oil, Phenyl ethyl alcohol, Pimento berry oil, Pimento leaf oil, Rosalin, Sandalwood oil, Sandenol, Sage oil, Clary sage, Sassafras oil, Spearmint oil, Spike lavender, Tagetes, Tea tree oil, Vanilin, Vetyver oil (Java), Wintergreen, Allocimene, Arbanex®, Arbanol®, Bergamot oils, Camphene, Alpha-Campholenic aldehyde, I-Carvone, Cineoles, Citral, Citronellol Terpenes, Alpha-Citronellol, Citronellyl Acetate, Citronellyl Nitrile, Para-Cymene, Dihydroanethole, Dihydrocarveol, d-Dihydrocarvone, Dihydrolinalool, Dihydromyrcene, Dihydromyrcenol, Dihydromyrcenyl Acetate, Dihydroterpineol, Dimethyloctanal, Dimethyloctanol, Dimethyloctanyl Acetate, Estragole, Ethyl-2 Methylbutyrate, Fenchol, Fernlol®, Florilys®, Geraniol, Geranyl Acetate, Geranyl Nitrile, Glidmint® Mint oils, Glidox®, Grapefruit oils, trans-2-Hexenal, trans-2-Hexenol, cis-3-Hexenyl Isovalerate, cis-3- Hexanyl-2-methylbutyrate, Hexyl Isovalerate, Hexyl-2-methylbutyrate, Hydroxycitronellal, lonone, Isobornyl Methylether, Linalool, Linalool Oxide, Linalyl Acetate, Menthane Hydroperoxide, I-Methyl Acetate, Methyl Hexyl Ether, Methyl-2-methylbutyrate, 2-Methylbutyl Isovalerate, Myrcene, Nerol, Neryl Acetate, 3-Octanol, 3-Octyl Acetate, Phenyl Ethyl-2-methylbutyrate, Petitgrain oil, cis-Pinane, Pinane Hydroperoxide, Pinanol, Pine Ester, Pine Needle oils, Pine oil, alpha-Pinene, beta-Pinene, alpha-Pinene Oxide, Plinol, Plinyl Acetate, Pseudo lonone, Rhodinol, Rhodinyl Acetate, Spice oils, alpha-Terpinene, gamma-Terpinene, Terpinene-4-OL, Terpineol, Terpinolene, Terpinyl Acetate, Tetrahydrolinalool, Tetrahydrolinalyl Acetate, Tetrahydromyrcenol, Tetralol®, Tomato oils, Vitalizair, Zestoral®.

The flavorant may include an oleoresin. Suitable types of oleoresins, include but are not limited to, basil, black pepper, capsicum, cardamom, celery seed, clove, coriander, cumin, fennel, fenu Greek, ginger, garlic, chili, green pepper, onion, nutmeg, anise, tumeric, vanilla, paprika, and many more which can be included in food emulsions.

In addition to essential oils and oleoresins, the flavorant may include other natural oil-based flavorants. The flavorant in the emulsion composition may include any mixtures or combinations of essential oils, oleoresins and natural oil-based flavorants.

### Nonionic Surfactant

The levels of nonionic surfactant useful in the present invention are determined by the amount of flavorant used and also by the levels deemed acceptable as food safe. The nonionic surfactants of the present invention are present at levels of from at least 3%, by weight of the composition, preferably from about 5% to about 15%, more preferably from about 5% to about 12% and most preferably from about 5% to about 10%. In one embodiment of the invention, the ratio of flavorant to nonionic surfactant is about 1:5 to about 1:12, more preferably about 1:5 to about 1:10, and most preferably about 1:5 to about 1:7. The one or more nonionic surfactants selected preferably have a hydrophilic-lipophilic balance (HLB) greater than about 10, more preferably a HLB of about 13 or greater. The HLB value of a nonionic surfactant blend is the weighted average of the blended surfactants. A HLB value of 10 or greater corresponds to forming a translucent to clear solution. A high HLB value is also desirable for an aqueous composition because the higher the HLB the more hydrophilic the surfactant. Therefore oil-in-water emulsions, like that of the present invention, usually require nonionic surfactant with a medium to high value.

In one embodiment of the invention, suitable nonionic surfactants of the present invention have a pour point of about 20° F. and are viscous, but pourable at a temperature range of 34-40° F. In one embodiment of the invention, the nonionic surfactants are food safe surfactants, including but not limited to, glycosides, sorbitan esters, ethoxylated sorbitan esters, sorbitan tristreate, monoglycerides, sucrose esters, ethoxylated castor oils, polyglycerol esters, and combinations thereof.

Surfactants, such as a phospholipid in the form of lecithin, may also act as flavor stabilizers, promotes uniformity of the flavor transfer, and act as release agents for peelability. Such surfactants may be present in amounts from 0 to 1 wt % or more based upon the weight of the flavorant coating composition. However, in the present invention, the use of surfactants will generally not be needed.

Other surfactants suitable for use in the coating compositions of the present invention include those surfactants which act as wetting agents for the cellulosic casing surface and/or as emulsifying agents for the coating composition. This may also include shirring lubricants. Nonlimiting examples of suitable surfactants include water dispersible or at least partially water-soluble surfactants such as alkylene oxide adducts of either fatty acids or partial fatty acid esters, for example, ethoxylated fatty acid partial esters of such polyols as anhydrosorbitols, glycerol, polyglycerol, pentaerythritol, and glucosides, as well as ethoxylated monodiglycerides, sorbitan trioleate, lecithin, and aliphatic polyoxyethylene ethers such as polyoxyethylene (23) lauryl ether.

Preferred surfactants include polyoxyethylene sorbitan fatty acid esters or mixtures thereof such as those sold under the trademark Tween™ 20 (polyoxyethylene (20) sorbitan monolaurate) or Tween™ 80 (polyoxyethylene 20 sorbitan monooleate) (both commercially available from ICI Americas Inc. of Wilmington, Del.), ethoxylated monodiglycerides or mixtures thereof such as those sold under the trademark Mazol 80 MGK (commercially available from Mazer Chemical, Inc. of Gurnee, Ill.), sorbitan trioleate (commercially available from ICI Americas Inc. under the trademark Span 85), and phospholipid including lecithin. An especially preferred surfactant is a mixture of ethoxylated monodiglycerides such as Mazol 80 MG K. Some surfactants are also known to act as anti-pleat lock. Suitable amounts of a surfactant, such as a mixture of ethoxylated monodiglycerides (Mazol 80) (sold under the trademark Mazol 80 MGK by Mazer Chemicals, Inc. of Gurnee, Ill., USA), may be present on the inner surface of the casing in order to wet the casing surface and assist in dispersing the antipleat lock agent, especially oils, and to emulsify and/or stabilize peeling aid compositions which contain components of varying solubilities. Desirably, amounts of a surfactant may range from about 0.005 to about 0.06 mg/in.sup.2 (0.0008-0.0009 mg/cm.sup.2) and preferably for a surfactant of ethoxylated monodiglycerides such as Mazol 80 from about 0.01 to 0.02 mg/in.sup.2 (0.002-0.003 mg/cm.sup.2).

Other suitable food safe nonionic surfactants include polysorbates, such as Tween™ 80, Tween™ 60 and Tween™ 20. In another embodiment of the invention the nonionic surfactant is a glycoside surfactant. In a preferred embodiment the glycoside surfactant is an alkyl polyglycoside. The alkyl polyglycoside surfactant may have linear or branched alkyl groups. Suitable alkyl polyglycoside surfactants preferably include a linear alkyl group. In preferred embodiment of the invention, the alkyl polyglycoside has about 6-22 carbons, more preferably about 6-12 carbons, even more preferably 6-10 carbons and most preferably 8-10 carbons.

The microemulsions created with essential oil, Tween, propylene glycol and water create an exothermic reaction upon dissolution. A set of experiments was conducted to determine which ingredients are responsible for the exothermic reaction. First, a solution of propylene glycol was diluted with water yielding about a 5 to 7° F. temperature change. Secondly, separate solutions of Tween™ 80 and Tween™ 20 were diluted with water resulting in about a 10 to 15° F. temperature change. Finally, a concentrated nanoemulsion composition of 57% Tween 20, 11% essential oil, 16% propylene glycol and 16% water was diluted with water which created about a 15 to 20° F. temperature increase. These results indicate that both the propylene glycol and the Tween surfactants are responsible for the exothermic reaction that results when the concentrated composition of the present invention is diluted with water.

The enthalpy change of solution is the quantity of heat produced or absorbed when a one mole of a substance is dissolved in a large volume of a solvent at constant pressure. In strong diapole interactions, the solute-solvent interaction may exceed the solvent-solvent interaction, resulting in excess energy in the form of heat. The dissolution process is termed an exothermic reaction with a negative heat of solution. The heat of solution of a substance is defined similarly: by energy absorbed, or endothermic energy, and energy released, or exothermic energy (expressed in “negative” kJ/mol). The heat of solution is one of the three dimensions of solubility analysis because a large negative heat of solution associated with exothermic reactions correlates to increased solubility.

In the present invention, the generation of heat as food emulsion composition is diluted with water is beneficial for a number of reasons. First, the generation of heat causes more of essential oil to be dispersed into the air, which enhances the fragrance and taste of the food product to the consumer. Therefore, less flavorant, essential oil in this case, may be used in the food emulsion composition while maintaining the same fragrance and taste benefit to a consumer. Secondly, the increase in heat upon dilution of the concentrated food emulsion may aid in the stability of the food product in which the flavorant nanoemulsion is being added.

### Water and Co-Solvents

The majority of the food emulsion composition of the present invention comprises water. In addition, the essential oil, nonionic surfactant and water combination of the present invention spontaneously forms a microemulsion. These qualities allow the food emulsion composition of the present invention to be formulated either as a concentrate that would be used to add to a food emulsion prior to use or as a more dilute food emulsion product where the flavorant is added in ready to use product. In one embodiment, in its concentrated for it could be added to a cooking oil or sauce to add flavors such as garlic and basil. In another embodiment, the food emulsion composition is added into the oil phase of a salad dressing or barbeque sauce to enhance or create additional flavor. As a food emulsion composition, which is added to an existing food composition including but not limited to, a sauce, marinate, dressing and the like, the water is at least 40%, by weight of the composition, preferably at least 50% and more preferably at least 55%. As a food emulsion composition which is ready to use, the amount of water is less than about 60%, by weight of the composition, preferably less than about 50% of the composition, and more preferably less than about 40% of the composition.

In another embodiment of the invention, the food emulsion composition may include other solvents in addition to water. Suitable other solvents include, but are not limited to, food grade C2-8-alcohols, including but not limited to, ethanol, propanol, glycerol, sugar alcohols or mixtures and/or isomers thereof. Suitable sugar alcohols, include but are not limited to, sorbitol, xilytol, lactitol, maltitol, mannitol, isomalt, erythritol and mixtures or combinations thereof. In one embodiment of the invention the food emulsion composition is essentially free of monohydric alcohols, including but not limited to ethanol, methanol, isopropanol, n-propanol, and t-butanol. In another embodiment, the food emulsion contains a single alcohol co-solvent without any additional polyol solvents. Other non-limiting examples of suitable solvents include: glycerin, 1,3-propanediol, 1,3-propanetriol, ethylene glycol and propylene glycol, and mixtures thereof. When present, the other solvents comprises about 8-25% by weight of the food emulsion composition, preferably about 10 to 20%, and most preferably about 10 to 15%.

### Buffers

Optionally, buffering and pH adjusting agents, can be added to the food emulsion composition. Suitable food grade buffers include, but are not limited to, organic acids, mineral acids, alkali metal and alkaline earth salts of silicate, metasilicate, polysilicate, borate, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2methylpropanol. Additional buffering agents for compositions of this invention include nitrogen-containing materials. Some examples are amino acids such as lysine or lower alcohol amines like mono-, di-, and tri-ethanolamine. Other nitrogen-containing buffering agents are tri(hydroxymethyl)amino methane (TRIS), 2-amino-2-ethyl-1,3-propanediol, 2-amino-2-methyl-propanol, 2-amino-2-methyl-1,3-propanol, disodium glutamate, N-methyl diethanolarnide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine(bicine) and N-tris(hydroxymethyl)methyl glycine(tricine). Other suitable buffers include potassium citrate, ammonium carbamate, citric acid, acetic acid. Mixtures of any of the above are also acceptable. In one embodiment of the invention the food emulsion composition contains only citric acid or citrate buffers and is essentially free from any other types of buffers. Useful inorganic buffers/alkalinity sources include ammonia, the alkali metal carbonates and alkali metal phosphates, e.g., sodium carbonate, sodium polyphosphate. For additional buffers see McCutcheon's Emulsifiers and Detergents, North American Edition, 1997, McCutcheon Division, MC Publishing Company Kirk and WO 95/07971, both of which are incorporated herein by reference.

When employed, the builder or buffer comprises at least about 0.001% and typically about 0.01-10% of the food emulsion composition. Preferably, the pH adjusting agent or buffer content is about 0.01-5% and more preferably from about 0.05%-2%.

### Additional Adjuvants

In a further aspect of the present invention, the food emulsion composition optionally includes one or more adjuncts. The adjuncts include, but are not limited to, fragrances, dyes and/or colorants, natural and artificial flavorants, vitamins and minerals, solubilizing materials, stabilizers, thickeners, foam controlling agents, hydrotropes, and/or mineral oils, enzymes, cloud point modifiers, preservatives, polymers and any combinations thereof.

The solubilizing materials, when used, include, but are not limited to, hydrotropes (e.g. water soluble salts of low molecular weight organic acids such as the sodium and/or potassium salts of xylene sulfonic acid). The acids, when used, include, but are not limited to, organic hydroxy acids, acetic acid, adipic acid, ascorbic acid, benzoic acid, lactic acid, phosphoric acid, oleic acid, malic acid, potassium acid tartrate, citric acids, keto acid, and the like. Thickeners, when used, include, but are not limited to, acacia, agar, xanthan gum, cornstarch, calcium carbonate, gelatin, gum tragacanth, starches, pectins, carrageenan, clays, beeswax, gellan gum, guar gum, alginates and any other food safe thickeners.

Foam controlling agent, when used, include, but are not limited to, acacia, silicones and other suitable defoamers. Enzymes, when used, include, but are not limited to, lipases and proteases, and/or hydrotropes and/or toluene sulfonates. Preservatives, when used, include, but are not limited to, acetic acid, adipic acid, ascorbic acid, butylated hydroxyanisole, butylated hydroxytoluene, EDTA, citric acid, calcium propinatesmethyl, ethyl and propyl parabens, short chain organic acids (e.g. acetic, lactic and/or glycolic acids), and/or short chain alcohols (e.g. ethanol and/or IPA).

The food emulsion composition of the present invention takes the form of a microemulsion. In a preferred embodiment, the microemulsion of the present invention forms spontaneously and creates a nano self-structured liquid (NSSL). The NSSL is thermodynamically stable over a wide range of temperatures and has droplets in the size range of 10 to 200 nm, preferably 20 to 150 nm, more preferably 20 to 100 nm. The NSSL is also asthetically clear and stable upon dilution and forms droplets in the range of about 10 to 100 nm. Furthermore, the NSSL may also form concentrates, which may be diluted as desired in either oil or water while a single phase is maintained and the nano-sized structured concentrate is intact. The NSSL concentrates form a clear and transparent liquid that shows no precipitates, crystalline matter or turbidity. The structured concentrate is of low viscosity, thermodynamically stable, does not separate, coalesce, aggregate, flocculate or cream at any ambient temperature even after prolonged storage.

The food emulsion compositions can be packaged in any suitable materials and housings known to one skilled in the art. It may be packaged as a concentrate in suitable containers or in ready-to-use dispensing systems. Thus they can be packaged in aerosol form in conventional aerosol containers or in liquid form in trigger pump spray bottles and squeeze bottles or pump spray bottles to produce an aerosol using a pump mechanism to build the necessary pressure to produce the aerosol. The compositions can also be impregnated into substrates, including but not limited to, grains, meats, fluids, gels, breads. These impregnated substrates can be packaged individually or in bulk form for individual consumption.

This food emulsion composition can be used effectively in large-scale industrial food and beverage production, in smaller-scale individual uses for individual consumption on an as desired basis. Therefore, an advantage of the present invention is its wide-ranging applicability, as it can be used in a broad array of food applications and offers the benefit of being safe, stable for long periods of time and cost efficient for use of flavorants.

### Formulations

Suitable concentrated food emulsion compositions of the present invention using polysorbate surfactants include, but are not limited to the following formulations:

TABLE 1
Concentrated Nanoemulsion Formulations

| | Concentrated | Concentrated | Concentrated | Concentrated |
|---|---|---|---|---|
| | Nanoemulsion | Nanoemulsion | Nanoemulsion | Nanoemulsion |
| Actives | Formulation 1 | Formulation 2 | Formulation 3 | Formulation 4 |
| Tween ™ 80 | 25.0% by weight | 50.0% by weight | 25.0% by weight | 50.0% by weight |
| Food Grade | 10% by weight | 20% by weight | 10% by weight | 20% by weight |
| Ethanol | | | | |
| Italian | 5.0% by weight | 10.0% by weight | | |
| Oregano | | | | |
| Essential Oil | | | | |
| Italian Garlic | | | 5.0% by weight | 10% by weight |
| Essential Oil | | | | |
| Water | Balance | Balance | Balance | Balance |

### Experimental

The compositions of the invention are illustrated by the specific formulations described below without being limited to those formulations. The following section contains non-limiting examples that are illustrative of the present invention. The sample salad dressing formulations were prepared to show types formulations that could be made according to the present invention. The nanoemulsion portion of the formulations below comprises: 5% by weight essential oil, 10% by weight food grade ethanol, 25% by weight Tween™ 80 and the remainder is water. The nanoemulsion dressing formulations were created by making the nanoemulsion first and then adding the nanoemulsion into the oil phase of the dressing formulation before the entire dressing ingredients are mixed together.

TABLE 2
Control Dressing and Nanoemulsion Dressing Formulations

| | | Oregano | |
|---|---|---|---|
| | | Salad | |
| | Control | Dressing | Oregano Salad |
| | Salad | 0.13% | Dressing |
| | Dressing | by wt | 0.07% by wt |
| Ingredients | Weight % | Nanoemulsion | Nanoemulsion |
| Water | 31-43 | 40.85 | 40.85 |
| Salt | 2-4 | 1.60 | 1.60 |
| Egg Yolk | 2-4 | 2.00 | 2.00 |
| Buttermilk Flavor | 2-4 | 0.20 | 0.20 |
| Sugar | 2.2-3.7 | 2.75 | 2.75 |
| Flavor Enhancers (MSG, | 0.0001-2.0 | 0.45 | 0.45 |
| ribotides) | | | |
| Spices (mustard, parsley, | 0.0001-2.0 | 1.19 | 1.19 |
| black pepper) | | | |
| Onion and Garlic Powder | 0.0001-2.0 | 0.50 | 0.50 |
| Disodium Phosphate | 0.0001-2.0 | 0.10 | 0.10 |
| Natural and Artifical | 0.0001-2.0 | | |
| Flavors | | | |
| Thickeners (xanthan gum | 0.0001-2.0 | 0.22 | 0.22 |
| and modified food starch) | | | |
| Food Grade Acids | 0.0001-2.0 | 1.20 | 1.20 |
| (vinegar and phosphoric) | | | |
| Soybean Oil | 39-51 | 40.00 | 40.00 |
| Oregano Oil | | 0.13 | 0.07 |
| Nanoemulsion | | | |

The following formulations in Table 3 and Table 4 were created using an essential oil or nanoemulsion formulation and salad dressing control as shown in Table 2. The tasting test was performed using 5 tasters. The tasters tested Sample No. 1a and Sample No. 1b and used those samples as a standard of comparison for the other samples in the test. The results are measured in plus signs which mean the flavor was stronger than the standard sample. The results are also measured with minus signs to show the sample was weaker than the standard sample. The equal sign shows that the taster indicated the sample was comparable to the standard sample 1a or 1b.

TABLE 3
Taste Test Oregano Salad Dressing Formulations

| | Italian Oregano | | | | | |
|---|---|---|---|---|---|---|
| Sam- | Essential Oil + | | | | | |
| ple | 500 g Salad | | | | | |
| No. | Dressing Control | Tester 1 | Tester 2 | Tester 3 | Tester 4 | Tester 5 |
| 1a | Oregano Oil | standard | standard | standard | standard | standard |
| | Nanoemulsion | | | | | |
| | 0.004% by weight | | | | | |
| | (tasting standard) | | | | | |
| 2a | Oregano Oil | − | − | − | − | − |
| | 0.004% by weight | | | | | |
| 3a | Oregano Oil | − | − | = | − | − |
| | 0.08% by weight | | | | | |
| 4a | Oregano Oil | + | = | + | = | = |
| | 0.025% by weight | | | | | |
| 5a | Oregano Oil | = | = | = | = | = |
| | Nanoemulsion | | | | | |
| | 0.004% by weight | | | | | |

The results show that each of the five testers found the taste of the regular essential oil composition at 0.004% was weaker than that of the nanoemulsion composition with the same amount of oregano essential oil. Furthermore four of the testers found that the standard essential oil at 0.008% was also weaker than the nanoemulsion composition with half of the amount of essential oil, 0.004%. In addition at least three of the testers thought the composition with 0.025% standard essential oil was comparable to the nanoemulsion composition at 0.004%. This taste test shows that the nanoemulsion composition at 0.004% oregano essential oil appears stronger than standard essential oil compositions with the same amount of essential oil and even appears stronger than essential oil compositions with two or more times the amount of essential oil.

Table 4 is similar to Table 3 in that it uses the same format for testing similar samples of garlic essential oil formulations against a comparable nanoformulation of garlic oil with a salad dressing base. The same plus, minus and equal signs are used for reporting the testing results of the tasters.

TABLE 4
Taste Test Garlic Salad Dressing Formulations

| Sam- | Garlic Essential | | | | | |
|---|---|---|---|---|---|---|
| ple | Oil + 500 g Salad | | | | | |
| No. | Dressing Base | Tester 1 | Tester 2 | Tester 3 | Tester 4 | Tester 5 |
| 1b | Garlic Oil | standard | standard | standard | standard | standard |
| | Nanoemulsion | | | | | |
| | 0.005% by weight | | | | | |
| | (tasting standard) | | | | | |
| 2b | Garlic Oil | − | − | − | − | − |
| | 0.005% by weight | | | | | |
| 3b | Garlic Oil 0.09% | − | − | − | − | − |
| | by weight | | | | | |
| 4b | Garlic Oil | − | = | = | − | − |
| | 0.015% by weight | | | | | |
| 5b | Garlic Oil | = | = | + | = | + |
| | Nanoemulsion | | | | | |
| | 0.005% by weight | | | | | |

The results show that each of the five testers found the taste of the regular essential oil composition at 0.005% and at 0.009% were both weaker than that of the nanoemulsion composition with the same amount of garlic essential oil. Furthermore three of the testers found that the standard garlic essential oil at 0.015% was comparable to the nanoemulsion composition with about one third the amount of garlic essential oil, 0.005%. This taste test shows that the nanoemulsion composition at 0.005% garlic essential oil appears stronger similar standard essential oil compositions with the same amount of essential oil and even appears stronger than essential oil compositions with two or more times the amount of essential oil.

The taste test results show that the dressing formulations with nanoemulsions are comparable to dressing formulations with at least twice the amount of essential oil flavorants. There is a significant cost savings associated with using less essential oil in a dressing formulation or other suitable food emulsions. In addition, the nanoemulsions with encapsulated flavorants, essential oils, showed better stability and less oxidation in comparison with standard nanoemulsion compositions. The compositions in Table 3 and Table 4 were evaluated by a tasting panel at seven months and at twelve months at room temperature. At seven months each of the standard, non-encapuslated essential oil dressing formulations showed the typical signs of oxidation and deterioration including rancid aroma, bitter flavor. In comparison, the nanoecapsulated essential oil dressing formulations did not show any of the typical signs of oxidation and deterioration even after twelve months of storage at room temperature. From the stability testing it appears that the nanoemulsion formulations provide better overall stability for dressing formulations and prevent undesirable attributes such as rancid and bitter flavors from being apparent.

The food emulsion composition of the present invention may be used in a concentrated nanoemulsion to be added to food or it can be provided in a diluted form as already added into a food or beverage product. These various forms and the wide variety of flavor ants which can be used to create a nanoemulsion composition provide a number of possibilities for compositions which would be in the spirit of the invention as described herein. While the present invention has been described with reference to what are presently considered to be the preferred embodiments, it is to be understood that the invention is not limited to these embodiments. To the contrary, the invention is intended to cover various modifications and equivalent arrangements included within the spirit and scope of the appended claims.

1. A food emulsion composition comprising:
(a) a food safe nonionic surfactant;
(b) a hydrophobic food flavorant selected from the group consisting of:
essential oil, oleoresin, oil-based natural flavors and mixtures and combinations thereof,
(c) a single alcohol co-solvent without any additional polyol solvents; and
(d) water
wherein the ratio of hydrophobic food flavorant to alcohol co-solvent is from about 1:2 to about 1:5 and wherein the ratio of hydrophobic food flavorant to food safe nonionic surfactant is about 1:5 to about 1:12.

2. The food emulsion composition of claim 1 wherein the food safe nonionic surfactant has an HLB value of at least 10.

3. The food emulsion composition of claim 1 wherein the hydrophobic food flavorant comprises an essential oil.

4. The food emulsion composition of claim 1 wherein the food safe surfactant comprises a polysorbate.

5. The food emulsion composition of claim 1 wherein the alcohol co-solvent comprises food grade ethanol.

6. The food emulsion composition of claim 1 wherein the food safe surfactant comprises a polyglycerol.

7. The food emulsion composition of claim 1 wherein the emulsion has a particle size of about 10 to 200 nm.

8. The food emulsion composition of claim 7 wherein the emulsion is a nanoemulsion which has a particle size of about 50 nm or less.

9. The food emulsion composition of claim 1 wherein the food emulsion composition contains at about 3 to 15% by weight of the hydrophobic natural flavorant.

10. A food emulsion composition comprising:
(a) at least 20% by weight of a food safe nonionic surfactant;
(b) about 3-15% by weight of a hydrophobic natural flavorant;
(c) about 8-25% alcohol co-solvent and
(d) water;
wherein the food emulsion composition there is at least 1:5 ratio of hydrophobic natural flavorant to food safe nonionic surfactant.

11. The food emulsion composition of claim 10 wherein the food safe nonionic surfactant comprises a polysorbate.

12. The food emulsion of claim 10 wherein the hydrophobic natural flavorant comprises an essential oil.

13. The food emulsion of claim 12 wherein the essential oil is selected from the group consisting of: garlic, thyme, basil, oregano, onion, pepper, lemon, lime, leek, nutmeg and mixtures or combination thereof.

14. The food emulsion composition of claim 10 wherein the alcohol co-solvent comprises a sugar alcohol selected from the group consisting of: sorbitol, xilytol, arabitol, lactitol, maltitol, glycerol, mannitol, isomalt, erythritol, and mixtures or combinations thereof.

15. The food emulsion composition of claim 10 wherein the food emulsion composition is essentially free of monohydric alcohols.

16. A food emulsion composition in the form of a nanoemulsion consisting essentially of:
(a) a polysorbate surfactant;
(b) an essential oil;
(c) an alcohol co-solvent; and
(d) water.

17. The food emulsion composition of claim 16 wherein the polysorbate surfactant is at least about 20% by weight of the composition.

18. The food emulsion composition of claim 16 wherein the essential oil is about 5-10% by weight of the composition.

19. The food emulsion composition of claim 16 wherein the alcohol co-solvent comprises a sugar alcohol selected from the group consisting of: sorbitol, xiytol, arabitol, lactitol, maltitol, glycerol, mannitol, isomalt, erythritol, and mixtures or combinations thereof.

20. The food emulsion composition of claim 16 wherein there is at least a 1:5 ratio of essential oil to food safe nonionic surfactant.
